(19) United States
(12) Patent Application Publication
(10) Pub. No.: US 2022/0072436 A1
(43) Pub. Date: Mar. 10, 2022

(54) METHOD AND APPARATUS FOR GAME LIVE-STREAMING

(71) Applicant: BEIJING DAJIA INTERNET INFORMATION TECHNOLOGY CO., LTD., Beijing (CN)

(72) Inventor: Xiao TANG, Beijing (CN)

(21) Appl. No.: 17/468,336

(22) Filed: Sep. 7, 2021

(30) Foreign Application Priority Data
Sep. 9, 2020 (CN) 202010943652.4

(51) Int. Cl. A63F 13/86; H04N 21/2187; H04N 21/431; A63F 13/358

(52) U.S. Cl. CPC A63F 13/86; A63F 13/358; H04N 21/4312; H04N 21/2187

(57) ABSTRACT

The present disclosure relates to systems, methods, non-transitory computer-readable media, and apparatuses for game live-streaming. In response to a live-streaming operation triggered by a live-streaming account, a live-streaming client displays a live-streaming interface of a target game, and displays a first notification message sent from a live-streaming server in the live-streaming interface. The first notification message is configured to indicate that a target account has performed a first operation triggered through a game recommendation control in the live-streaming interface, and the first notification message is sent by the live-streaming server after the target account has performed the first operation.

### CROSS REFERENCE

This application claims priority to Chinese Patent Application No. 202010943652.4, titled “METHOD AND APPARATUS FOR GAME LIVE-STREAMING” filed on Sep. 9, 2020, the entire content of which are incorporated herein by reference.

### TECHNICAL FIELD

The present disclosure relates to the field of Internet technology, and in particular, to a method and apparatus for live-streaming games.

### BACKGROUND

Online games are becoming more and more popular. There are a large number of mobile games, webpage or browser games, computer games, console games, and other games or game platforms on the market. Game manufacturers and operators usually place game advertisements through the Internet to promote and publicize the games.

### SUMMARY

According to some arrangements of the present disclosure, a method for game live-streaming, which is applied to a live-streaming client, includes in response to a live-streaming operation triggered by a live-streaming account, displaying a live-streaming interface of a target game. A first notification message sent from a live-streaming server is displayed in the live-streaming interface. The first notification message is configured to indicate that a target account has performed a first operation. The first operation is triggered through a game recommendation control in the live-streaming interface. The first notification message is sent by the live-streaming server after the target account has performed the first operation.

According to some arrangements of the present disclosure, a method for game live-streaming that is applied to an audience client includes in response to a trigger operation indicating that a target account watches a target game live-streamed by a live-streaming account, displaying a live-streaming interface containing a game recommendation control. In response to a first operation triggered by the target account through the game recommendation control, target prompt information for notifying the target account has performed the first operation is sent to a live-streaming server, so that, in response to receiving the target prompt information, the live-streaming server sends a first notification message indicating that the target account has performed the first operation to a live-streaming client.

According to some arrangements of the present disclosure, a method for game live-streaming, which is applied to a live-streaming server, includes receiving target prompt information sent by an audience client. The target prompt information is configured to notify that a target account has performed a first operation, and is sent by the audience client after the target account has performed the first operation. The first operation is triggered by the target account through a game recommendation control in the live-streaming interface of the target game. A first notification message is sent to a live-streaming client. The first notification message is configured to indicate that the target account has performed the first operation. The live-streaming client is configured to display the first notification message in the live-streaming interface of the target game.

According to some arrangements of the present disclosure, a device for game live-streaming, which is applied to a live-streaming client, includes a processor and a memory for storing instructions executable by the processor. The processor is configured to display a live-streaming interface of a target game in response to a live-streaming operation triggered by a live-streaming account. A first notification message sent from a live-streaming server is displayed in the live-streaming interface. The first notification message is configured to indicate that a target account has performed a first operation. The first operation is triggered through a game recommendation control in the live-streaming interface, and the first notification message is sent by the live-streaming server after the target account has performed the first operation.

According to some arrangements of the present disclosure, there is provided a device for game live-streaming. The device for game live-streaming is applied to an audience client and may include: a processor; and memory for storing instructions executable by the processor; wherein the processor is configured to: display a live-streaming interface containing a game recommendation control, in response to a trigger operation that a target account watches a target game live-streamed by a live-streaming account; and send target prompt information for notifying the target account has performed the first operation to a live-streaming server, in response to a first operation triggered by the target account through the game recommendation control, wherein the live-streaming server is configured to send a first notification message indicating that the target account has performed the first operation to a live-streaming client, in response to receiving the target prompt information.

According to some arrangements of the present disclosure, a device for game live-streaming, which is applied to a live-streaming server, includes a processor and a memory for storing instructions executable by the processor. The processor is configured to receive target prompt information sent by an audience client. The target prompt information is configured to notify that a target account has performed a first operation, and is sent by the audience client after the target account has performed the first operation. The first operation is triggered by the target account through a game recommendation control in the live-streaming interface of the target game. A first notification message is sent to a live-streaming client. The first notification message is configured to indicate that the target account has performed the first operation, and the live-streaming client is configured to display the first notification message in the live-streaming interface of the target game.

### BRIEF DESCRIPTION OF THE DRAWINGS

FIG. 1 is a schematic diagram showing an application scenario according to some exemplary arrangements.

FIG. 2 is a flow chart showing a method for game live-streaming according to some exemplary arrangements.

FIG. 3 is a schematic diagram showing a recommendation interface according to some exemplary arrangements.

FIG. 4A is a schematic diagram showing a game live-streaming interface according to some exemplary arrangements.

FIG. 4B is a schematic diagram showing a game live-streaming interface according to some exemplary arrangements;

FIG. 5 is a schematic diagram showing a game live-streaming interface according to some exemplary arrangements;

FIG. 6 is a flow chart showing a method for game live-streaming according to some exemplary arrangements;

FIG. 7 is a flow chart showing a method for game live-streaming according to some exemplary arrangements;

FIG. 8 is a flow chart showing a method for game live-streaming according to some exemplary arrangements;

FIG. 9 is a flowchart showing a method for game live-streaming according to some exemplary arrangements;

FIG. 10 is an interaction sequence diagram of a method for game live-streaming according to some exemplary arrangements;

FIG. 11 is a block diagram showing an apparatus for game live-streaming according to some exemplary arrangements;

FIG. 12 is a block diagram showing an apparatus for game live-streaming according to some exemplary arrangements;

FIG. 13 is a block diagram showing an apparatus for game live-streaming according to some exemplary arrangements;

FIG. 14 is a block diagram showing an apparatus for game live-streaming according to some exemplary arrangements;

FIG. 15 is a block diagram showing an apparatus for game live-streaming according to some exemplary arrangements;

FIG. 16 is a block diagram showing an electronic device according to some exemplary arrangements.

### DETAILED DESCRIPTION

In order to enable those of ordinary skill in the art to better understand the technical solutions of the present disclosure, the technical solutions in arrangements of the present disclosure will be described clearly and completely with reference to the accompanying drawings.

It should be noted that the terms “first”, “second”, etc. in the specification and claims of the present disclosure and the above-mentioned drawings are used to distinguish similar accounts, and are not necessarily used to describe a specific sequence or order. It should be understood that the data used in this way can be interchanged under appropriate circumstances so that arrangements of the present disclosure described herein can be implemented in an order other than those illustrated or described herein. The implementation manners described in the following exemplary arrangements do not represent all implementation manners consistent with the present disclosure. Rather, they are merely examples of apparatus and methods consistent with some aspects of the present disclosure as detailed in the appended claims.

Some of the terms that appear in the disclosure will be explained as follows.

The term “and/or” in arrangements of the present disclosure describes the association relationship of the associated account, and means that there may be three kinds of relationships, for example, A and/or B, which can mean that A alone, A and B exist at the same time, and B alone. The character “/” generally indicates that the associated accounts are in an “or” relationship. The term “at least one of A, B, and C” generally means that there are multiple conditions of A, B, C, A+B, A+C, B+C, or A+B+C.

The term “electronic device” in arrangements of the present disclosure may be a mobile phone, a computer, a digital broadcasting terminal, a messaging device, a game console, a tablet device, a medical device, a fitness device, a personal digital assistant, etc.

In arrangements of the present disclosure, the term “client” or “user-side” refers to an application that corresponds to a server and provides local services to clients. Except for some applications that only run locally, the application is generally installed on ordinary clients and need to cooperate with the server-side to run. After the development of the Internet, the more commonly used user-sides include webpage browsers used in the World Wide Web, email clients for sending and receiving emails, and client software for instant messaging. For this type of application, there needs to be a corresponding server and service program in the network to provide respective services, such as database services, email services, etc., so that a specific communication connection needs to be established between the client and the server-side to ensure the normal operation of the application.

The term “recommendation interface” in arrangements of the present disclosure is a user-oriented user interface that includes or shows at least one game to be recommended. All games in the recommendation interface are available for game promotion by an anchor. In addition, the recommendation interface may further include game introduction. The game introduction has specific resource allocation rules and so on, for example, if a user downloads the game in a live-streaming room, how many resources the anchor can get, and if the user recharges in the live-streaming room later, how many resources the anchor can get.

In arrangements of the present disclosure, the term “serves the client” means that the content of the service is such as providing resources to the client and saving client data. Taking the game service-side (the game server) as an example, it serves the game client. The content of the service includes providing login for the client, saving game player information, and providing players with online games. This is also different from a Single-Player Game. The login of the game client requires authorization of the game service-side. For example, the game service-side provides the player with a logger, and the logger is a necessary tool to connect to the game service-side. The logger can be understood as an authorization file of the game service-side.

The application scenarios described in arrangements of the present disclosure are intended to more clearly illustrate the technical solutions of arrangements of the present disclosure, and do not constitute a limitation on the technical solutions provided by arrangements of the present disclosure. Those of ordinary skill in the art will know that with the development of new application scenarios, it appears that the technical solutions provided by arrangements of the present disclosure are equally applicable to similar technical problems. In the description of the present disclosure, unless otherwise specified, “multiple” means one or more.

As shown in FIG. 1, which is a schematic diagram of an application scenario in some arrangements of the present disclosure, the application scenario includes multiple terminal devices and servers. Each terminal device and the server 130 can communicate with each other directly or indirectly. Each terminal device corresponds to a user. In FIG. 1, a user A corresponds to a first terminal device 110 and a user B corresponds to a second terminal device 120. In fact, the number of terminal devices is not limited. In some cases, respective terminal devices may communicate with each other through the server 130. In other cases, direct communication may be established between the terminal device and the terminal device. The method of direct communication between the terminal device and the terminal device may be called a point-to-point communication. In this case, some interaction processes between the terminal device and the terminal device may not require the transfer of the server 130.

A short video application (APP) may be installed in each terminal device, and the user can conduct a live-streaming or watch the live-streaming from an anchor through the short video APP. To simplify the description, the short video APP installed in the first terminal device 110 may be referred to as a first short video APP 111, and the short video APP installed in the second terminal device 120 may be referred to as a second short video APP 121. The short video APP involved in arrangements of the present disclosure may be software, or a client such as a webpage, applet, etc. The server is a live-streaming server corresponding to the software or webpage, applet, etc. The specific type of the client is not limited.

In some arrangements, the communication network is a wired network or a wireless network. The terminal device and the server can be directly or indirectly connected through wired or wireless communication, which is not limited in the present disclosure.

In arrangements of the present disclosure, the terminal device is an electronic device used by the user. The electronic device may be a personal computer, a mobile phone, a tablet computer, a notebook, an e-book reader, or computer equipment which has a certain computing capability and runs instant messaging software and websites, or social software and websites. Each terminal device communicates with a server through a wireless network. The server may be an independent physical server, or a server cluster or a distributed system composed of multiple physical servers. The server may also be a cloud server which can provide basic cloud computing services such as cloud services, cloud databases, cloud computing, cloud functions, cloud storage, network services, cloud communications, middleware services, domain name services, security services, Content Delivery Network (CDN), and big data and artificial intelligence platforms.

In the arrangement of the present disclosure, the user A can conduct the game live-streaming through the first short video APP 111. At this time, the account that the user A logs in in the first short video APP 111 is a live-streaming account, and the user A is the anchor. The user B can watch the live-streaming of the user A through the second short video APP 121. At this time, the account that the user B logs in in the second short video APP 121 is a target account, and the user B is an audience (or called a fan). User A can install a first game client on the first terminal device 110 before the game live-streaming. User B can install a second game client on the second terminal device 120 before watching the live-streaming of User A, or user B can trigger a download of a second game client through a game recommendation control in the live-streaming interface during the viewing process, and then install the second game client on the second terminal device 120. Taking the first short video APP 111 as a live-streaming client or an anchor client and the second short video APP 121 as an audience client as an example, the method for game live-streaming proposed in the arrangement of the present disclosure will be described in detail below.

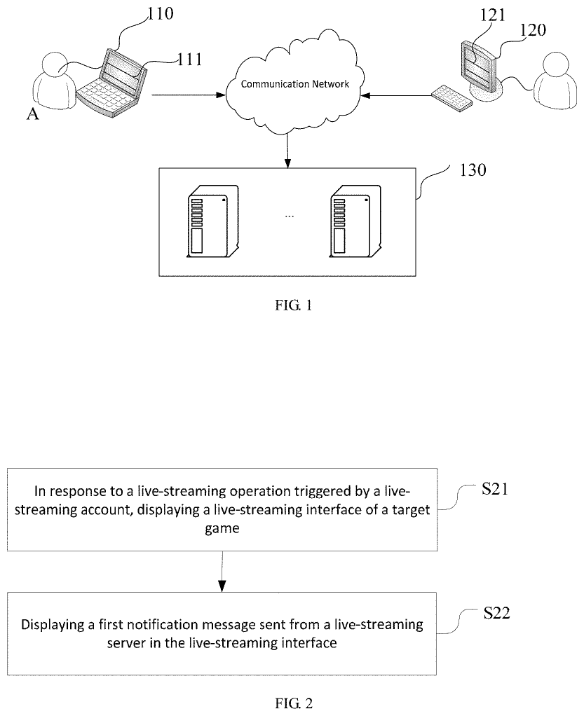

FIG. 2 is a flow chart showing a method for game live-streaming according to some exemplary arrangements. As shown in FIG. 2, the method for game live-streaming is applied to a live-streaming client and includes the followings.

In S21, in response to a live-streaming operation triggered by a live-streaming account, a live-streaming interface of a target game is displayed.

In S22, a first notification message sent from a live-streaming server is displayed in the live-streaming interface. The first notification message is configured to indicate that a target account has performed a first operation. The first operation is triggered via a game recommendation control in the live-streaming interface. The first notification message is sent by the live-streaming server after the target account has performed the first operation.

The target game may be selected by the live-streaming account. On this basis, in an arrangement, in response to the live-streaming operation triggered by the live-streaming account, a recommendation interface including at least one game is displayed, and in response to a selection operation of the live-streaming account to select the target game in the recommendation interface, the live-streaming interface of the target game is displayed by calling a game client of the target game.

In arrangements of the present disclosure, the anchor can select a game to be promoted in this live-streaming from the recommendation interface before starting the game live-streaming. A promotion game list panel for promoting the game may also display a corresponding game introduction, and the game introduction has specific details about how many resources the anchor can get, for example, if a user downloads the game in a live-streaming room, how many resources the anchor can get or allocate, and if the user recharges in the live-streaming room later, and how many resources the anchor can get or allocate.

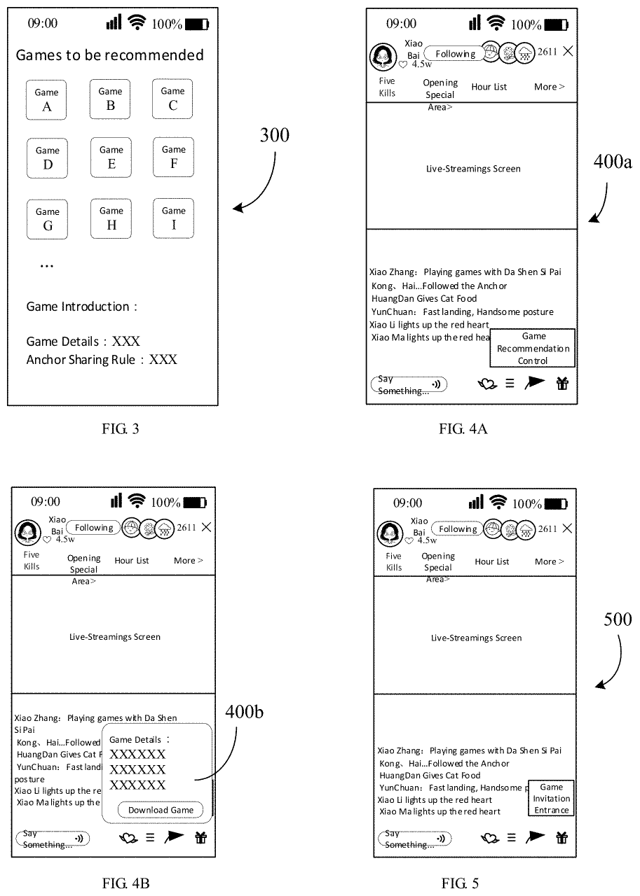

FIG. 3 is a schematic diagram of a recommendation interface 300 in some arrangements of the present disclosure. The recommendation interface 300 shown in FIG. 3 is also called as the promotion game list panel. The games to be recommended are displayed in the promotion game list panel, such as Game A, Game B, Game C, . . . , Game I . . . as shown in 3. In addition, game introduction, game details, anchor sharing rule (i.e., rule about how many resources the anchor gets), etc. can also be displayed in the promotion game list panel. In arrangements of the present disclosure, the anchor sharing rule is a resource allocation rule, which refers to how to allocate resources to the anchor when the target account performs the first operation, or the game account corresponding to the target account performs the second operation. The anchor sharing rule shown herein may be a second resource allocation rule adopted in response to the live-streaming server allocates target resources to the live-streaming account.

In addition, game details, etc. can also be popped up after the anchor selects the target game, displayed in a pop-up window, a floating layer, or a new page, etc., which are not specifically limited here.

After the anchor selects the target game to be promoted, he or she can start to play the game in the live-streaming room, and at the same time, the live-streaming client reports game information to the server. The game information specifically refers to information about the target game. In addition, identification information of the game account of the anchor may be further reported to the server.

It should be noted that after the target game is selected by the live-streaming account, the live-streaming interface of the target game is displayed by calling the game client of the target game. However, considering that the game client of the target game i.e., the first game client mentioned above, may have been installed in advance on the first terminal device, or may not be installed, or may be uninstalled after installation, etc., so displaying the live-streaming interface of the target game by calling the game client of the target game may be implemented in the following two cases.

Case 1: in the case of or in response to detecting that the game client of the target game has been installed locally, the game client is directly called to display the live-streaming interface of the target game.

Case 2: in the case of or in response to detecting that the game client of the target game is not installed locally, in response to monitoring that the live-streaming account has installed the game client, the game client is called to display the live-streaming interface of the target game. The game client may be installed in response to triggering a download operation for the target game.

In other words, after user A selects game A as the target game through the recommendation interface, firstly, it is checked whether the game client of game A has been installed on the first terminal device, and if so, the game client of game A is directly called to conduct a live-streaming. Otherwise, the game client of game A needs to be downloaded first. At this time, in response to monitoring that the live-streaming account has triggered a download operation for the target game and the game client of the target game is installed, the game client is called to perform the live-streaming.

In the above arrangement, by combining the game promotion and the live-streaming scene, the anchor can promote the game through the game live-streaming, and the game can be efficiently delivered to users who are interested in, so that the efficiency of human-machine interaction is improved.

In some arrangements, when the audience is watching the live-streaming of the live-streaming account, in response to the triggering operation that the target account watches the target game of the live-streaming account, a live-streaming interface containing a game recommendation control is displayed on the audience client, as shown in FIG. 4A, which is a live-streaming interface 400a containing the game recommendation control according to some arrangements of the present disclosure. When the user watches the live-streaming through the audience client, for example, the user B enters the live-streaming room of the user A, the game recommendation control can be displayed in the live-streaming interface 400a of the audience client. For example, as shown in FIG. 4A, the game recommendation control may be a button.

It should be noted that when user B executes the trigger operation of watching the target game live-streamed by the live-streaming account, the audience client sends a live-streaming watch request to the live-streaming server. The live-streaming watch request contains the identification information of the live-streaming account that the target account requests to watch. After receiving the live-streaming watch request, the live-streaming server returns to the audience client the current ongoing video stream of the live-streaming account and the game information of the target game. When the audience client receives the video stream and game information, it can display the live-streaming interface of the target game, and further display the game recommendation control of the target game in the live-streaming interface.

After that, when user B triggers the execution of the first operation through the game recommendation control, the audience client sends target prompt information to the live-streaming server in response to the first operation. The target prompt information is configured for notifying that the target account has performed the first operation. After receiving the target prompt information, the live-streaming server sends to the live-streaming client the first notification message indicating that the target account has performed the first operation.

In arrangements of the present disclosure, the first operation refers to downloading the game client of the target game, downloading and installing the game client of the target game, opening the game client of the target game, or viewing the game details of the target game, and so on.

For example, after user B clicks on the game recommendation control in the live-streaming interface 400a shown in FIG. 4A, a game details interface 400b of the target game can be displayed, and the game details interface 400b contains the detailed introduction of the target game. In addition, an open or download button may also be displayed, as shown in FIG. 4B. The download button is shown in FIG. 4B. In addition, the game details interface 400b shown in FIG. 4B is in the form of a pop-up window. After the user B clicks the game recommendation button, the pop-up window (also called a panel) shown in FIG. 4B pops up, and that is the game details interface. There are details of the target game, including game classification, gameplay introduction, etc. displayed in the pop-up window.

It should be noted that the open button or the download button can be displayed after detecting whether the game client of the target game is installed locally. In the case that the game client of the target game, that is, the second game client, is installed locally on the second terminal device, the open button is displayed. In the case that the game client of the target game is not installed locally on the second terminal device, the download button is displayed.

In arrangements of the present disclosure, after user B triggers the first operation through the game recommendation control, the audience client sends to the live-streaming server the target prompt information for notifying that the target account has performed the first operation. After receiving the target prompt information, the live-streaming server can forward the target prompt information to the game server. In addition, the live-streaming server can also forward to the live-streaming client the first notification message indicating that the target account has performed the first operation, and the live-streaming client will display the first notification message in the live-streaming interface.

The first notification message includes at least one of the followings: the target prompt information and a first amount of target resources allocated for the live-streaming account. The first amount of target resources is allocated by the live-streaming server to the live-streaming account after the target account has performed the first operation. In arrangements of the present disclosure, the first notification message may only include the target prompt information, may only include the first amount of target resources allocated for the live-streaming account, or may include the target prompt information and the first amount of target resources.

For example, after a fan of an anchor downloads the target game, the anchor can receive a system message indicating that the user or the fan has successfully downloaded the game. At this time, the first notification message only includes the target prompt information. In the case where the local income of the anchor is further displayed, the first notification message also includes the first amount of target resources allocated for the live-streaming account.

In an arrangement, the first amount of target resources are allocated by the live-streaming server to the live-streaming account, and is a part of or all target resources selected, by the live-streaming server, from a third amount of target resources. The third amount of target resources are target resources that the game server allocates for the live-streaming server. The first amount is not greater than the third amount.

There are also many ways for the live-streaming client to display the first notification message in the live-streaming interface, such as scrolling display in a designated area in the live-streaming interface or displaying through a pop-up window, etc., which are not limited herein.

The process of resource allocation is described in detail below.

After the game server receives the target prompt information sent by the live-streaming server to notify that the target account has performed the first operation, the game server allocates the third amount of target resources to the live-streaming server according to a first resource allocation rule, and the live-streaming server receives the third amount of target resources allocated by the game server.

For example, after receiving the target prompt information sent by the live-streaming server, the game server allocates the third amount of target resources to the live-streaming server, which is 1000 target resources. After receiving the 1000 target resources allocated by the game server, the live-streaming server divides, according to a second resource allocation rule, the 1,000 target resources into two parts, one part is allocated to the live-streaming account, and the rest, i.e. the other part, is allocated to the live-streaming platform. For example, if the second resource allocation rule is set to allocate 50% to the anchor, i.e. the live-streaming account, and 50% to the live-streaming platform, the first amount of target resources allocated to live-streaming account is 500 target resources.

The above is based on the 50% allocation ratio set in the second resource allocation rule. Based on this, for different games, after the target account performs the first operation through the game recommendation control, the game server can select 50% of the third amount of target resources allocated to the live-streaming server and allocate it to the live-streaming account. In some arrangements, the resource allocation rules corresponding to different games can also be different. For example, the allocation ratio corresponding to game A is 50% of the third amount, the allocation ratio corresponding to game B is 60% of the third amount, and the allocation ratio corresponding to game C is 70%, etc., which is not specifically limited here.

It should be noted that the target resource in arrangements of the present disclosure may be an electronic resource related to live-streaming, such as a live-streaming pendant. The target resource may also be an electronic resource related to the target game, such as game props, a red packet, virtual currency, and the like.

By allocating target resources to the live-streaming account, on one hand, the enthusiasm of high-quality anchors to promote the game can be improved, and on the other hand, the efficiency of game advertisements can also be improved, and the game advertisements can be targeted-delivered to users who are interested in.

In some implementations, the audience clicks to download (or open) the target game through the game recommendation control, the audience client downloads and installs (or opens) the game, and also automatically copies the anchor's identification (ID) in the game through a system clipboard. The specific implementation process will be described below.

In response to the triggering operation that the target account watches the target game live-streamed by the live-streaming account, the audience client sends the live-streaming watch request to the live-streaming server. The live-streaming server can return the live-streaming video stream or game information of the target game to the audience client. In addition, the live-streaming server may further return the identification information of the game account corresponding to the live-streaming account to the audience client. Furthermore, the audience client automatically copies the identification information of the game account corresponding to the live-streaming account through the system clipboard, that is, ID of the anchor in the game. In response to detecting the game client that calls the target game, the identification information is sent to the game client, and the game client can automatically add friends.

In some arrangements, after receiving the identification information of the game account corresponding to the live-streaming account issued by the audience client, the game client can establish, according to the identification information, an association relationship between the game account corresponding to the target account and the game account corresponding to the live-streaming account. The implementation process of the association relationship is as follows. After searching for the game account corresponding to the live-streaming account based on the identification information copied from the system clipboard, friends are automatically added, and the association relationship here can refer to game friends.

It should be noted that the game account corresponding to the live-streaming account in arrangements of the present disclosure may be the same as the live-streaming account. However, for example, when logging in to the short video APP and game client through third-party software, the live-streaming account and the corresponding game account may also be different. The game account logged in when the live-streaming account performs the game live-streaming corresponds to the live-streaming account.

Similarly, the game account corresponding to the target account refers to the game account that the target account logs in during the process of watching the game live-streaming, or the game account logged in when logging in to the second game client on the second terminal device after watching the game live-streaming.

In arrangements, by automatically adding friends, users who are interested in the game can be found, improving the efficiency of human-machine interaction.

In some arrangements, user B may also trigger the execution of the second operation through the second game client on the second terminal device. The second operation may refer to game check-in, continuous check-in, log in, continuous log in, recharge, participate in activities, etc. In response to the second operation triggered by the game account corresponding to the target account through the game interface, the game client sends operation information corresponding to the second operation to the game server. After receiving operation information corresponding to the second operation sent by the game client, the game server verifies the operation information. After the verification is successful, the game server allocates, according to the first resource allocation rule, a fourth amount of target resources to the live-streaming server. The live-streaming server selects a second amount of target resources from the fourth amount of target resources according to the second resource allocation rule, and allocates the second amount of target resources to the live-streaming account. The second amount is not greater than the fourth amount.

For example, user B has checked in for 7 consecutive days, and the second operation refers to checked in for 7 consecutive days. The second game client reports the corresponding operation information to the game server. The operation information here refers to the detailed information of the second operation performed by the target account, which may include the time of operation, etc.

After receiving the operation information reported by the game client, the game server can verify the operation information, judge whether these operations are actually performed, etc., to determine that the target account has performed the second operation. After the verification is successful, according to the first resource allocation rule, the game server allocates the fourth amount of target resources to the live-streaming server.

For example, the first resource allocation rule includes: a target resource of 300 is allocated for checked in for 3 consecutive days; a target resource of 700 is allocated for checked in for 7 consecutive days; a target resource of 1500 is allocated for checked in for 15 consecutive days.

Therefore, in case that the target account is checked in for 7 consecutive days, in response to the successful verification, the game server determines to allocate 700 target resources to the live-streaming server according to the first resource allocation rule. 700 is the fourth amount. After receiving the fourth amount of target resources, the live-streaming server allocates the second amount of target resources to the live-streaming account according to the second resource allocation rule. For example, when 50% is allocated to the live-streaming account and 50% to the live-streaming platform, the second amount allocated to the live-streaming account is 350.

In the above-mentioned implementation manner, the user still performs some second operations through the game account corresponding to the target account after watching the live-streaming, which once again brings revenue to the live-streaming account, and can also increase the enthusiasm of high-quality anchors to promote the game through the live-streaming and improve the efficiency of game advertising.

In some arrangements, after receiving the fourth amount of target resources allocated by the game server, selecting the second amount of target resources from the fourth amount of target resources and sending the second amount of target resources to the live-streaming account, the live-streaming server may further send a second notification message to the live-streaming client. The second notification message is configured to indicate that the game account corresponding to the target account has performed the second operation. After receiving the second notification message, the live-streaming client displays the second notification message in the live-streaming interface of the target game.

In arrangements of the present disclosure, the second notification message is similar to the first notification message, and the second notification message includes at least one of the following: game prompt information for notifying that the game account corresponding to the target account has performed the second operation, and the second amount of the target resources allocated to the live-streaming account. The second amount of the target resources is allocated by the live-streaming server, in response to that the game account corresponding to the target account performs the second operation, to the live-streaming account.

In other words, the second notification message may only include game prompt information, may only include the second amount of target resources allocated for the live-streaming account, or may include both game prompt information and the second amount of target resources allocated for the live-streaming account.

For example, in case that a fan or a user has checked in for 7 consecutive days in the game, the anchor receives a system message that the user has checked in for 7 consecutive days, and displays the anchor's current income. The system message that the user has checked in for 7 consecutive days is the above-mentioned game prompt information, and the anchor's current income is the second amount of target resources allocated to the live-streaming account this time.

Similar to the first notification message, the live-streaming client may display the second notification message in the live-streaming interface in a form of scrolling display in a designated area in the live interface, or in a form of a pop-up window, etc., which is not limited here.

In some implementations, user B may also send game invitations to the anchor and audiences watching the anchor through the game client. In some arrangements, in response to a sharing operation triggered by the game account corresponding to the target account, the game client may jump to the audience client for sharing, which is a game invitation. At this time, the audience client also sends a game invitation request to the live-streaming server, and the live-streaming server forwards the game invitation request to the live-streaming client. After receiving the game invitation request, the live-streaming client displays, in the live-streaming interface, an invitation entrance corresponding to the game invitation request.

In arrangements of the present disclosure, the game invitation request may contain a game room number, and the game room number may be a unique ID generated by the system. The game invitation entrance can be in the form of a link or an invitation control, etc. Audiences watching the live-streaming or anchors can enter the game room by clicking the link, copying the link, etc., or can directly enter the game room by clicking the invitation control. For example, as shown in FIG. 5, which is a schematic diagram of a live-streaming interface 500 illustrated in arrangements of the present disclosure, the game invitation entrance displayed in the live-streaming interface 500 is displayed when the user sends a game invitation to the anchor. The entrance may be in the form of a button, etc. Invitation animation, invitation information, etc. may also be displayed on the invitation entrance.

In arrangements of the present disclosure, for example, when the user A clicks the invitation control, in response to the trigger operation of the invitation entrance, the live-streaming client may call the game client, and the game client displays the game interface of the target game. For example, after a fan audience downloads the game, he or she can invite the anchor to play the game together in the live-streaming room.

In arrangements, by combining the game promotion and the live-streaming scene, the anchor promotes the game through the live-streaming game, so that the delivery efficiency of game advertisement placement can be improved and the game advertisements can be targeted-delivered to users who are interested in. The anchor live streams the game to attract interested users, guide users to download the game, and increase the conversion rate. In addition, the target resource can be allocated to the live-streaming account according to the operations performed by the target account or the game account corresponding to the target account, so as to increase the enthusiasm of high-quality anchors to promote the game.

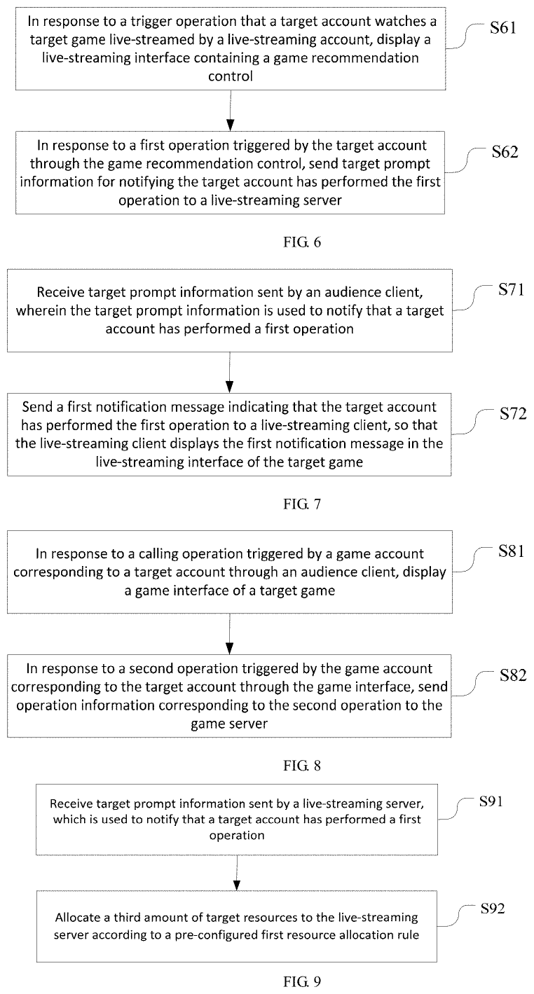

FIG. 6 is a flow chart showing a method for game live-streaming according to some exemplary arrangements. As shown in FIG. 6, the method for game live-streaming is executed by the audience client and includes the followings.

In S61, in response to a trigger operation that a target account watches a target game live-streamed by a live-streaming account, a live-streaming interface containing a game recommendation control is displayed.

In S62, in response to a first operation triggered by the target account through the game recommendation control, target prompt information for notifying the target account has performed the first operation is sent to a live-streaming server. In response to receiving the target prompt information, the live-streaming server sends a first notification message indicating that the target account has performed the first operation to a live-streaming client.

In some arrangements, the first notification message includes at least one of the followings: the target prompt information and the first amount of target resources allocated for the live-streaming account. The first amount of target resources are allocated by the live-streaming server to the live-streaming account after the target account has performed the first operation.

In some arrangements, in response to the trigger operation that the target account watches the target game live-streamed by a live-streaming account, before the first operation triggered by the target account through the game recommendation control, the method further includes receiving identification information of a game account corresponding to the live-streaming account issued by the live-streaming server.

After the first operation triggered by the target account through the game recommendation control, the method further includes calling a game client of the target game, and sending the identification information to the game client. The game client establishes an association relationship between the game account corresponding to the target account and the game account corresponding to the live-streaming account according to the identification information.

Through the above implementation, the game promotion and the live-streaming scene are combined, the live-streaming account can promote a game through the live-streaming of the game, and the audience can watch the live-streaming in the live-streaming room, and perform target operations via the game recommendation control in response to displaying the game recommendation control of the target game in the live-streaming interface of the audience-side, which can effectively improve the delivery efficiency of game advertising and the efficiency of game advertising while increasing the enthusiasm of the promotion live-streaming of the game. In addition, the anchor can live-streaming the game to attract interested users and guide users to perform target operations, so as to increase the conversion rate.

FIG. 7 is a flow chart showing a method for game live-streaming according to some exemplary arrangements. As shown in FIG. 7, the method is executed by a live-streaming server and includes the followings.

In S71, target prompt information sent by an audience client is received. The target prompt information is configured to notify that a target account has performed a first operation, and is sent by the audience client after the target account has performed the first operation. The first operation is triggered by the target account via a game recommendation control in the live-streaming interface of the target game.

In S72, a first notification message indicating that the target account has performed the first operation is sent to a live-streaming client. The live-streaming client is configured to display the first notification message in the live-streaming interface of the target game.

In some arrangements, the first notification message includes at least one of the followings: the target prompt information and the first amount of target resources allocated for the live-streaming account. The first amount of target resources are allocated by the live-streaming server to the live-streaming account after the target account has performed the first operation.

In some arrangements, in response to receiving the target prompt information sent by the audience client, the method further includes the followings:

forwarding the target prompt information to a game server;

receiving a third amount of target resources allocated by the game server, wherein the third amount is determined by the game server according to a pre-configured first resource allocation rule; and

according to a pre-configured second resource allocation rule, selecting the first amount of target resources from the third amount of target resources and sending the first amount of target resources to the live-streaming account, and according to the first amount, updating the amount of target resources corresponding to the live-streaming account in an account server, wherein the first amount is not greater than the third amount.

In some arrangements, the method further includes:

receiving a fourth amount of target resources allocated by the game server, wherein the fourth amount of target resources are allocated by the game server after receiving operation information corresponding to a second operation sent by the game client, and the operation information is sent by the game client after the second operation triggered by the game account corresponding to the target account through the game interface of the target game; and

according to a pre-configured second resource allocation rule, selecting a second amount of target resources from the fourth amount of target resources and sending the second amount of target resources to the live-streaming account, and according to the second amount, updating the amount of target resources corresponding to the live-streaming account in an account server, wherein the second amount is not greater than the fourth amount.

In some arrangements, in response to selecting the second amount of target resources from the fourth amount of target resources and sending to the live-streaming account, the method further includes: sending a second notification message to the live-streaming client, wherein the second notification message is used to indicate that the game account corresponding to the target account has performed the second operation and wherein the live-streaming client is configured to display the second notification message in the live-streaming interface of the target game.

In some arrangements, the second notification message includes at least one of the followings: the game prompt information used to notify that the game account corresponding to the target account has performed the second operation and the second amount of target resources allocated for the live-streaming account. The second amount of target resources are allocated by the live-streaming server to the live-streaming account after the game account corresponding to the target account has performed the second operation.

In some arrangements, the method further includes forwarding a game invitation request sent by the audience client to the live-streaming client, wherein the game invitation request is sent by the audience client to live-streaming server after the game account corresponding to the target account triggers a game sharing operation, and wherein the live-streaming client is configured to display an invitation entrance corresponding to the game invitation request in the live-streaming interface of the target game.

Through the above implementation, the game promotion and the live-streaming scene are combined, the live-streaming account can promote a game through the live-streaming of the game, and the audience can watch the live-streaming in the live-streaming room, and perform target operations via the game recommendation control in response to displaying the game recommendation control of the target game in the live-streaming interface of the audience-side, which can effectively improve the delivery efficiency of game advertising and the efficiency of game advertising while increasing the enthusiasm of the promotion live-streaming of the game. In addition, the anchor can live-streaming the game to attract interested users and guide users to perform target operations, so as to increase the conversion rate.

FIG. 8 is a flow chart showing a method for game live-streaming according to some exemplary arrangements. As shown in FIG. 8, it is applied to a game client and includes followings:

In S81, a game interface of a target game is displayed in response to a calling operation triggered by a game account corresponding to a target account through an audience client, wherein the calling operation is sent after the target account has triggered a first operation through a game recommendation control in a live-streaming interface.

In S82, operation information corresponding to the second operation is sent to the game server, in response to a second operation triggered by the game account corresponding to the target account through the game interface.

In some arrangements, the method further includes: according to the identification information of the game account corresponding to the live-streaming account issued by an audience client, establishing an association relationship between the game account corresponding to the target account and the game account corresponding to the live-streaming account, wherein the identification information of the game account is sent after the target account has triggered the first operation through the game recommendation control in the live-streaming interface.

Through the above implementation, the game promotion and the live-streaming scene are combined, the live-streaming account can promote a game through the live-streaming of the game, and the audience can watch the live-streaming in the live-streaming room, and perform target operations via the game recommendation control in response to displaying the game recommendation control of the target game in the live-streaming interface of the audience-side, which can effectively improve the delivery efficiency of game advertising and the efficiency of game advertising while increasing the enthusiasm of the promotion live-streaming of the game. In addition, the anchor can live-streaming the game to attract interested users and guide users to perform target operations, so as to increase the conversion rate.

FIG. 9 is a flow chart showing a method for game live-streaming according to some exemplary arrangements. As shown in FIG. 9, it is applied to a game server and includes the followings:

In S91, target prompt information sent by a live-streaming server is received, wherein the target prompt information is configured to notify that a target account has performed a first operation, and the target prompt information is sent by the live-streaming server after the target account has triggered a first operation through a game recommendation control in a live-streaming interface of a target game.

In S92, a third amount of target resources is allocated to the live-streaming server, according to a pre-configured first resource allocation rule, and the live-streaming server is configured to select a first amount of target resources allocated for a live-streaming account from the third amount of target resources according to a pre-configured second resource allocation rule, wherein the first amount is not greater than the third amount.

In some arrangements, the method further includes:

receiving operation information corresponding to a second operation sent by a game client, and verifying the operation information, wherein the operation information is sent by the game client after the target account has triggered the second operation through a game interface of the target game;

after the verification is successful, allocating a fourth amount of target resources to the live-streaming server according to the pre-configured first resource allocation rule, and the live-streaming server is configured to select a second amount of target resources allocated for the live-streaming account from the fourth amount of target resources according to the pre-configured second resource allocation rule, wherein the second amount is not greater than the fourth amount.

Through the above implementation, the game promotion and the live-streaming scene are combined, the live-streaming account can promote a game through the live-streaming of the game, and the audience can watch the live-streaming in the live-streaming room, and perform target operations via the game recommendation control in response to displaying the game recommendation control of the target game in the live-streaming interface of the audience-side, which can effectively improve the delivery efficiency of game advertising and the efficiency of game advertising while increasing the enthusiasm of the promotion live-streaming of the game. In addition, the anchor can live-streaming the game to attract interested users and guide users to perform target operations, so as to increase the conversion rate.

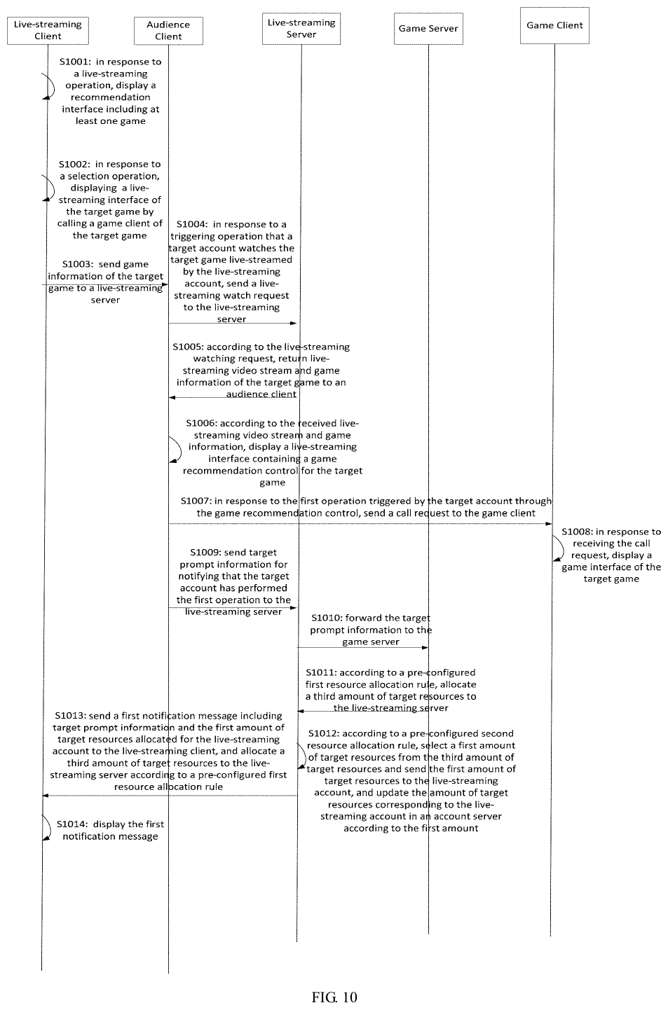

FIG. 10 is a complete flow chart showing a method for game live-streaming according to some exemplary arrangements, which specifically includes the followings:

In S1001, a recommendation interface including at least one game is displayed by a live-streaming client, in response to a live-streaming operation triggered by a live-streaming account;

In S1002, a live-streaming interface of the target game is displayed by the live-streaming client through calling a game client of the target game, in response to a selection operation of the live-streaming account to select a target game in the recommendation interface.

In S1003, game information of the target game is sent by the live-streaming client to a live-streaming server.

In S1004, a live-streaming watch request is sent by an audience client to the live-streaming server, in response to a triggering operation that a target account watches the target game live-streamed by the live-streaming account.

In S1005, according to the live-streaming watching request, live-streaming video stream of the target game and game information of the target game are returned by the live-streaming server to an audience client.

In S1006, a live-streaming interface containing a game recommendation control for the target game is displayed by the audience client, according to the received live-streaming video stream and game information.

In S1007, a call request is sent by the audience client to the game client, in response to the first operation triggered by the target account through the game recommendation control.

In S1008, a game interface of the target game is displayed in response to the game client receiving the call request.

In S1009, target prompt information is sent by the audience client to the live-streaming server and the target prompt information is configured to notify that the target account has performed the first operation.

In S1010, the target prompt information is forwarded by the live-streaming server to the game server.

In S1011, a third amount of target resources is allocated by the game server to the live-streaming server, according to a pre-configured first resource allocation rule.

In S1012, a first amount of target resources is selected by the live-streaming server from the third amount of target resources according to a pre-configured second resource allocation rule and is sent to the live-streaming account, and the amount of target resources corresponding to the live-streaming account is updated in an account server according to the first amount.

In S1013, a first notification message including target prompt information and the first amount of target resources allocated for the live-streaming account are sent by the live-streaming server to the live-streaming client.

In S1014, the first notification message is displayed by the live-streaming client.

In addition, the game account corresponding to the target account can also trigger a second operation through the game client, and at this time, the followings are also included (not shown in FIG. 10):

In S1015, operation information corresponding to the second operation is sent by the game client to the game server in response to the second operation triggered by the game account corresponding to the target account through the game interface.

In S1016, the operation information corresponding to the second operation sent by the game client is received and verified by the game server.

In S1017, in response to the verification is successful, a fourth amount of target resources to the live-streaming server is allocated by the game server according to the pre-configured first resource allocation rule.

In S1018, according to the pre-configured second resource allocation rule, a second amount of target resources from the fourth amount of target resources is selected and is sent by the live-streaming server to the live-streaming account, and the amount of target resources corresponding to the live-streaming account in the account server is updated according to the second amount.

In S1020, a second notification message including game prompt information and the second amount of target resources allocated for the live-streaming account is sent by the live-streaming server to the live-streaming client.

In S1021, the second notification message is displayed by the live-streaming client.

FIG. 11 is a block diagram showing an apparatus for game live-streaming 1100 according to some exemplary arrangements. It is applied to a live-streaming client, referring to FIG. 11, the apparatus for game live-streaming 1100 includes a first displaying unit 1101.

The first displaying unit 1101 is configured to in response to a live-streaming operation triggered by a live-streaming account, display a live-streaming interface of a target game; and display a first notification message sent from a live-streaming server in the live-streaming interface, wherein the first notification message is configured to indicate that a target account has performed a first operation, the first operation is triggered through a game recommendation control in the live-streaming interface, and the first notification message is sent by the live-streaming server after the target account has performed the first operation.

In some arrangements, the first notification message includes at least one of the followings: target prompt information notifying that the target account has performed the first operation; and a first amount of target resources allocated for the live-streaming account, wherein the first amount of target resources are allocated by the live-streaming server to the live-streaming account after the target account has performed the first operation.

In some arrangements, the first displaying unit 1101 is further configured to: in response to the live-streaming operation triggered by the live-streaming account, display a recommendation interface comprising at least one game; and in response to the live-streaming account selecting the target game in the recommendation interface, displaying the live-streaming interface of the target game by calling a game client of the target game to.

In some arrangements, the first displaying unit 1101 is further configured to: in the case of or in response to detecting that the game client of the target game has been installed locally, displaying the live-streaming interface of the target game by calling directly the game client, or in the case of or in response to detecting that the game client of the target game is not installed locally, displaying the live-streaming interface of the target game by calling the game client in response to that the live-streaming account has installed the game client by triggering a download operation for the target game.

In some arrangements, the apparatus for game live-streaming 1100 further includes a second displaying unit 1102 and a first response unit 1103. The second displaying unit 1102 is configured to receive a game invitation request sent by the live-streaming server, and display an invitation entrance corresponding to the game invitation request in the live-streaming interface, wherein the game invitation request is sent by the audience client to the live-streaming server after the game account corresponding to the target account triggers a game sharing operation. The first response unit 1103 is configured to in response to a triggering operation on the invitation entrance, displaying the game interface of the target game by calling the game client.

In some arrangements, the apparatus for game live-streaming 1100 further includes a third displaying unit 1104, which is configured to display a second notification message sent from the live-streaming server in the live-streaming interface, wherein the second notification message is configured to indicate that the game account corresponding to the target account has performed a second operation, the second operation is triggered by the game client, and the second notification message is sent by the live-streaming server after the game account has performed the second operation.

In some arrangements, the second notification message comprises at least one of the followings: game prompt information notifying that the game account corresponding to the target account has performed the second operation; and a second amount of target resources allocated for the live-streaming account, wherein the second amount of target resources are allocated by the live-streaming server to the live-streaming account after the game account corresponding to the target account has performed the second operation.

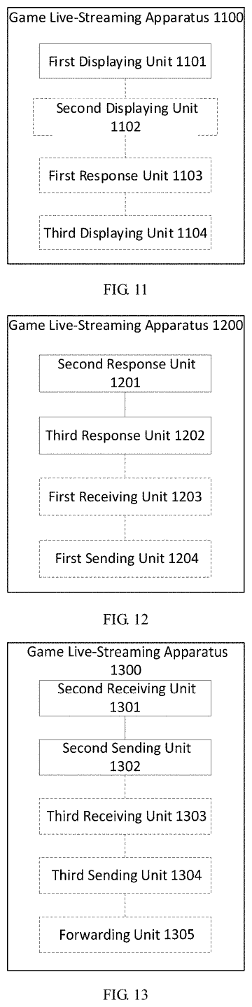

FIG. 12 is a block diagram showing an apparatus for game live-streaming 1200 according to some exemplary arrangements. It is applied to an audience client, referring to FIG. 12, the apparatus for game live-streaming 1200 includes a second response unit 1201 and a third response unit 1202.

The second response unit 1201 is configured to in response to a trigger operation that a target account watches a target game live-streamed by a live-streaming account, display a live-streaming interface containing a game recommendation control.

The third response unit 1202 is configured to in response to a first operation triggered by the target account through the game recommendation control, send target prompt information for notifying the target account has performed the first operation to a live-streaming server, the live-streaming server is configured to send a first notification message indicating that the target account has performed the first operation to a live-streaming client in response to receiving the target prompt information.

In some arrangements, the first notification message comprises at least one of the followings: target prompt information notifying that the target account has performed the first operation; and a first amount of target resources allocated for the live-streaming account, wherein the first amount of target resources are allocated by the live-streaming server to the live-streaming account after the target account has performed the first operation.

In some arrangements, the apparatus for game live-streaming 1200 further includes a first receiving unit 1203 and a first sending unit 1204. The first receiving unit 1203 is configured to after the second response unit 1201 responds to the trigger operation that the target account watches the target game live-streamed by a live-streaming account, before the first response unit 1103 responds to the first operation triggered by the target account through the game recommendation control, receive identification information of a game account corresponding to the live-streaming account sent by the live-streaming server.

The first sending unit 1204 is configured to after the first response unit 1103 responds to the first operation triggered by the target account through the game recommendation control, call a game client of the target game, and send the identification information to the game client, and establish, by the game client, an association relationship between the game account corresponding to the target account and the game account corresponding to the live-streaming account according to the identification information.

FIG. 13 is a block diagram showing an apparatus for game live-streaming 1300 according to some exemplary arrangements. It is applied to a live-streaming server, referring to FIG. 13, the apparatus for game live-streaming 1300 includes a second receiving unit 1301 and a second sending unit 1302.

The second receiving unit 1301 is configured to receive target prompt information sent by an audience client, wherein the target prompt information is configured to notify that a target account has performed a first operation, and is sent by the audience client after the target account has performed the first operation, and wherein the first operation is triggered by the target account through a game recommendation control in the live-streaming interface of the target game.

The second sending unit 1302 is configured to send a first notification message to a live-streaming client, wherein the first notification message is configured to indicate that the target account has performed the first operation, and the live-streaming client is configured to display the first notification message in the live-streaming interface of the target game.

In some arrangements, the first notification message comprises at least one of the followings: target prompt information notifying that the target account has performed the first operation; and a first amount of target resources allocated for the live-streaming account, wherein the first amount of target resources are allocated by the live-streaming server to the live-streaming account after the target account has performed the first operation.

In some arrangements, the second receiving unit 1301 is further configured to forward the target prompt information to a game server; receive a third amount of target resources allocated by the game server, wherein the third amount is determined by the game server according to a pre-configured first resource allocation rule; select a first amount of target resources from the third amount of target resources according to a pre-configured second resource allocation rule; send the first amount of target resources to the live-streaming account; and update an amount of target resources corresponding to the live-streaming account in an account server based on the first amount, wherein the first amount is not greater than the third amount.

In some arrangements, the apparatus for game live-streaming 1300 further includes a third receiving unit 1303, which is configured to receive a fourth amount of target resources allocated by the game server, wherein the fourth amount of target resources are allocated by the game server after receiving operation information sent by the game client, the operation information is sent by the game client in response to a second operation, and the second operation is triggered by the game account corresponding to the target account through the game interface of the target game; select a second amount of target resources from the fourth amount of target resources according to a pre-configured second resource allocation rule; send the second amount of target resources to the live-streaming account; and update an amount of target resources corresponding to the live-streaming account in an account server based on the second amount, wherein the second amount is not greater than the fourth amount.

In some arrangements, the apparatus for game live-streaming 1300 further includes a third sending unit 1304, which is configured to send a second notification message to the live-streaming client, wherein the second notification message is configured to indicate that the game account corresponding to the target account has performed the second operation, and wherein the live-streaming client is configured to display the second notification message in the live-streaming interface of the target game.

In some arrangements, the second notification message includes at least one of the followings: game prompt information notifying that the game account corresponding to the target account has performed the second operation; and a second amount of target resources allocated for the live-streaming account, wherein the second amount of target resources are allocated by the live-streaming server to the live-streaming account after the game account corresponding to the target account has performed the second operation.

In some arrangements, the apparatus for game live-streaming 1300 further includes a forwarding unit 1305, which is configured to forward a game invitation request to the live-streaming client, wherein the game invitation request is sent by the audience client after the game account corresponding to the target account triggers a game sharing operation, and wherein the live-streaming client is configured to display an invitation entrance corresponding to the game invitation request in the live-streaming interface of the target game.

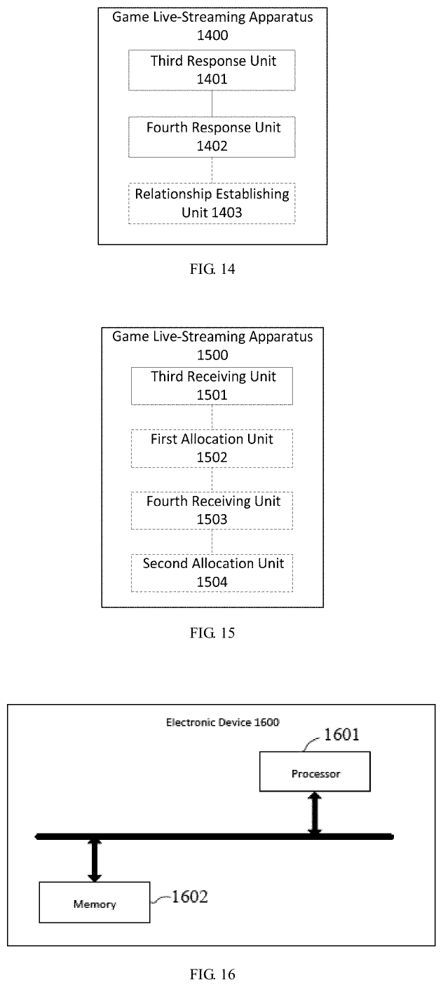

FIG. 14 is a block diagram showing an apparatus for game live-streaming 1400 according to some exemplary arrangements. It is applied to a game client, referring to FIG. 14, the apparatus for game live-streaming 1400 includes a third response unit 1401 and a fourth response unit 1402.

The third response unit 1401 is configured to in response to a calling operation triggered by a game account corresponding to a target account through an audience client, display a game interface of a target game, wherein the calling operation is sent after the target account has triggered a first operation through a game recommendation control in a live-streaming interface.

The fourth response unit 1402 is configured to in response to a second operation triggered by the game account corresponding to the target account through the game interface, send operation information corresponding to the second operation to the game server.

In some arrangements, the apparatus for game live-streaming 1400 further includes a relationship establishing unit 1403, which is configured to according to the identification information of the game account corresponding to the live-streaming account issued by an audience client, establish an association relationship between the game account corresponding to the target account and the game account corresponding to the live-streaming account, wherein the identification information of the game account is sent after the target account has triggered the first operation through the game recommendation control in the live-streaming interface.

FIG. 15 is a block diagram showing an apparatus for game live-streaming 1500 according to some exemplary arrangements. It is applied to a game server, referring to FIG. 15, the apparatus for game live-streaming 1500 includes a third receiving unit 1501 and a first allocation unit 1502.

The third receiving unit 1501 is configured to receive target prompt information sent by a live-streaming server for notifying a target account has performed a first operation, wherein the target prompt information is sent by the live-streaming server in response to the target account has triggered a first operation through a game recommendation control in a live-streaming interface of a target game.

The first allocation unit 1502 is configured to allocate a third amount of target resources to the live-streaming server according to a pre-configured first resource allocation rule, and the live-streaming server is configured to select a first amount of target resources allocated for a live-streaming account from the third amount of target resources according to a pre-configured second resource allocation rule wherein the first amount is not greater than the third amount

In some arrangements, the apparatus for game live-streaming 1500 further includes a fourth receiving unit 1503 and a second allocation unit 1504.

The fourth receiving unit 1503 is configured to receive operation information corresponding to a second operation sent by a game client, and verify the operation information, wherein the operation information is sent by the game client in response to the target account has triggered the second operation through a game interface of the target game.

The second allocation unit 1504 is configured to, in response to the verification is successful, allocate a fourth amount of target resources to the live-streaming server according to the pre-configured first resource allocation rule, and the live-streaming server is configured to select a second amount of target resources allocated for the live-streaming account from the fourth amount of target resources according to the pre-configured second resource allocation rule, wherein the second amount is not greater than the fourth amount.

Regarding the apparatus in the foregoing arrangement, the specific manner in which each unit executes the request has been described in detail in the arrangement of the method, and detailed description will not be given here.

FIG. 16 is a block diagram showing an electronic device 1600 according to some exemplary arrangements. The device 1600 includes: processor 1601; and memory 1602 for storing instructions executable by the processor 1601; wherein, the processor 1601 is configured to execute instructions to implement the method for game live-streaming in arrangements of the present disclosure.

In some exemplary arrangements, a storage medium including instructions is also provided, such as a memory 1602 including instructions, and the foregoing instructions may be executed by the processor 1601 of the electronic device 1600 to complete the foregoing method. Alternatively, the storage medium may be a non-transitory computer-readable storage medium, for example, the non-transitory computer-readable storage medium may be ROM, random access memory (RAM), CD-ROM, magnetic tape, floppy disk, optical data storage device, etc.

Arrangements of the present disclosure also provide a computer program product. When the computer program product runs on an electronic device, the electronic device executes and implements any one of the above-mentioned methods for game live-streaming or any one of the methods for game live-streaming involved in arrangements of the present disclosure.

It can be understood that in the present disclosure, “a plurality of” or “multiple” refer to two or more than two, and other quantifiers are similar. The singular forms “a”, “said” and “the” are also intended to include plural forms, unless the context clearly indicates other meanings.

It can be further understood that, unless otherwise specified, “connected” includes a direct connection between the two without other components, and also includes an indirect connection between the two with other elements.

It can be further understood that although the operations in arrangements of the present disclosure are described in a specific order in the drawings, they should not be understood as requiring these operations to be performed in the specific order shown or in a serial order, or requiring all the operations shown to be performed to get the desired result. In certain circumstances, multitasking and parallel processing may be advantageous.

Those skilled in the art will easily think of other arrangements of the present disclosure after considering the specification and practicing the arrangements disclosed herein. This application is intended to cover any variations, uses, or adaptive changes of the present disclosure. These variations, uses, or adaptive changes follow the general principles of the present disclosure and include common knowledge or conventional technical means in the technical field that are not disclosed in the present disclosure. The description and arrangements are to be regarded as exemplary only, and the true scope and spirit of the present disclosure are pointed out by the following claims.

It should be understood that the present disclosure is not limited to the precise structure that has been described above and shown in the drawings, and various modifications and changes can be made without departing from its scope. The scope of the present disclosure is only limited by the appended claims.

What is claimed is:

1. A method for game live-streaming, applied to a live-streaming client, comprising:
in response to a live-streaming operation triggered by a live-streaming account, displaying a live-streaming interface of a target game; and
displaying a first notification message sent from a live-streaming server in the live-streaming interface, wherein the first notification message is configured to indicate that a target account has performed a first operation, the first operation is triggered through a game recommendation control in the live-streaming interface, and the first notification message is sent by the live-streaming server after the target account has performed the first operation.

2. The method of claim 1, wherein the first notification message comprises at least one of:
target prompt information notifying that the target account has performed the first operation; and
a first amount of target resources allocated for the live-streaming account,
wherein the first amount of target resources are allocated by the live-streaming server to the live-streaming account after the target account has performed the first operation.

3. The method of claim 1, wherein said in response to the live-streaming operation triggered by the live-streaming account, displaying the live-streaming interface of the target game comprises:
in response to the live-streaming operation triggered by the live-streaming account, displaying a recommendation interface comprising at least one game; and
in response to the live-streaming account selecting the target game in the recommendation interface, displaying the live-streaming interface of the target game by calling a game client of the target game.

4. The method of claim 3, wherein said displaying the live-streaming interface of the target game by calling a game client of the target game comprises:
in response to detecting that the game client of the target game has been installed locally, displaying the live-streaming interface of the target game by calling directly the game client, or
in response to detecting that the game client of the target game is not installed locally, displaying the live-streaming interface of the target game by calling the game client in response to that the live-streaming account has installed the game client, in which the game client is installed in response to triggering a download operation for the target game.

5. The method of claim 1, further comprising:
receiving a game invitation request sent by the live-streaming server, and displaying an invitation entrance corresponding to the game invitation request in the live-streaming interface, wherein the game invitation request is sent by the audience client to the live-streaming server after the game account corresponding to the target account triggers a game sharing operation; and
in response to a triggering operation on the invitation entrance, displaying the game interface of the target game by calling the game client.

6. The method of claim 1, further comprising:
displaying a second notification message sent from the live-streaming server in the live-streaming interface, wherein the second notification message is configured to indicate that the game account corresponding to the target account has performed a second operation, the second operation is triggered by the game client, and the second notification message is sent by the live-streaming server after the game account has performed the second operation.

7. The method of claim 6, wherein the second notification message comprises at least one of followings:
game prompt information notifying that the game account corresponding to the target account has performed the second operation; and
a second amount of target resources allocated for the live-streaming account,
wherein the second amount of target resources is allocated by the live-streaming server to the live-streaming account after the game account corresponding to the target account has performed the second operation.

8. A device for game live-streaming, applied to a live-streaming client, comprising:
a processor;
memory for storing instructions executable by the processor;
wherein the processor is configured to:
display a live-streaming interface of a target game in response to a live-streaming operation triggered by a live-streaming account; and
display a first notification message sent from a live-streaming server in the live-streaming interface, wherein the first notification message is configured to indicate that a target account has performed a first operation, the first operation is triggered through a game recommendation control in the live-streaming interface, and the first notification message is sent by the live-streaming server after the target account has performed the first operation.

9. The device of claim 8, wherein the first notification message comprises at least one of followings:
target prompt information notifying that the target account has performed the first operation; and
a first amount of target resources allocated for the live-streaming account,
wherein the first amount of target resources are allocated by the live-streaming server to the live-streaming account after the target account has performed the first operation.

10. The device of claim 8, wherein the processor is configured to:
display a recommendation interface comprising at least one game in response to the live-streaming operation triggered by the live-streaming account; and
display the live-streaming interface of the target game by calling a game client of the target game, in response to the live-streaming account selecting the target game in the recommendation interface.

11. The device of claim 10, wherein the processor is configured to:
in response to detecting that the game client of the target game has been installed locally, display the live-streaming interface of the target game by calling directly the game client, or
in response to detecting that the game client of the target game is not installed locally, display the live-streaming interface of the target game by calling the game client in response to that the live-streaming account has installed the game client, in which the game client is installed in response to triggering a download operation for the target game.

12. The device of claim 8, wherein the processor is further configured to:
receive a game invitation request sent by the live-streaming server, and display an invitation entrance corresponding to the game invitation request in the live-streaming interface, wherein the game invitation request is sent by the audience client to the live-streaming server after the game account corresponding to the target account triggers a game sharing operation; and
display the game interface of the target game by calling the game client in response to a triggering operation on the invitation entrance.

13. The device of claim 8, wherein the processor is further configured to:
display a second notification message sent from the live-streaming server in the live-streaming interface, wherein the second notification message is configured to indicate that the game account corresponding to the target account has performed a second operation, the second operation is triggered by the game client, and the second notification message is sent by the live-streaming server after the game account has performed the second operation.

14. The device of claim 13, wherein the second notification message comprises at least one of followings:
game prompt information notifying that the game account corresponding to the target account has performed the second operation; and
a second amount of target resources allocated for the live-streaming account,
wherein the second amount of target resources is allocated by the live-streaming server to the live-streaming account after the game account corresponding to the target account has performed the second operation.

15. A method for game live-streaming, applied to a live-streaming server, comprising:
receiving target prompt information sent by an audience client, wherein the target prompt information is configured to notify that a target account has performed a first operation, and is sent by the audience client after the target account has performed the first operation, and wherein the first operation is triggered by the target account through a game recommendation control in the live-streaming interface of the target game; and
sending a first notification message to a live-streaming client, wherein the first notification message is configured to indicate that the target account has performed the first operation, and the live-streaming client is configured to display the first notification message in the live-streaming interface of the target game.

16. The method of claim 15, wherein the first notification message comprises at least one of followings:
target prompt information notifying that the target account has performed the first operation; and
a first amount of target resources allocated for the live-streaming account,
wherein the first amount of target resources are allocated by the live-streaming server to the live-streaming account after the target account has performed the first operation.

17. The method of claim 15, further comprising:
forwarding the target prompt information to a game server;
receiving a third amount of target resources allocated by the game server, wherein the third amount is determined by the game server according to a first resource allocation rule;
selecting the first amount of target resources from the third amount of target resources according to a second resource allocation rule;
sending the first amount of target resources to the live-streaming account; and
updating an amount of target resources corresponding to the live-streaming account in an account server based on the first amount, wherein the first amount is not greater than the third amount.

18. The method of claim 15, further comprising:
receiving a fourth amount of target resources allocated by the game server, wherein the fourth amount of target resources are allocated by the game server after receiving operation information sent by the game client, the operation information is sent by the game client in response to a second operation, and the second operation is triggered by the game account corresponding to the target account through the game interface of the target game;
selecting a second amount of target resources from the fourth amount of target resources according to a second resource allocation rule;
sending the second amount of target resources to the live-streaming account; and
updating an amount of target resources corresponding to the live-streaming account in an account server based on the second amount, wherein the second amount is not greater than the fourth amount.

19. The method of claim 18, further comprising:
sending a second notification message to the live-streaming client, wherein the second notification message is configured to indicate that the game account corresponding to the target account has performed the second operation, and wherein the live-streaming client is configured to display the second notification message in the live-streaming interface of the target game.

20. The method of claim 15, further comprising:
forwarding a game invitation request to the live-streaming client, wherein the game invitation request is sent by the audience client after the game account corresponding to the target account triggers a game sharing operation, and wherein the live-streaming client is configured to display an invitation entrance corresponding to the game invitation request in the live-streaming interface of the target game.
